(19) United States
(12) Patent Application Publication
(10) Pub. No.: US 2011/0211713 A1
(43) Pub. Date: Sep. 1, 2011

(54) ATTACHABLE GUITAR AMPLIFIER AND EFFECTS APPARATUS

(76) Inventor: Eric Cavallo-Romano, Astoria, NY (US)

(21) Appl. No.: 13/094,225

(22) Filed: Apr. 26, 2011

(51) Int. Cl. G10H 1/00

(52) U.S. Cl. 381/118

(57) ABSTRACT

A combination pickup, multi-effects processor and amplifying apparatus that is attachable, and detachable to an acoustical guitar and does enable a player of an acoustic guitar to produce, modify and amplify a myriad of sounds, and tones that are normally associated with that of an electrical guitar. The apparatus performs these functions while remaining an independent self-contained accessory that can be easily attached to, and detached from, an acoustic guitar with minimal intrusion to the body structure, appearance, and acoustical properties of the guitar

### BACKGROUND OF THE INVENTION

1. Field of the Invention

The present invention relates to guitar amplifiers and more particularly pertains to attachable multi-effect amplifiers for acoustic guitars

2. Description of the Prior Art

The use of amplifiers for acoustical guitars is known in the prior art. More specifically, amplifiers for acoustic guitars Heretofore devised and utilized are known to consist basically of familiar, and obvious structural configuration, notwithstanding the myriad of designs encompassed by the crowded prior art which have been developed for the fulfillment of the numerous objectives

Known prior art includes U.S. Pat. No. 4,464,967; U.S. Pat. No. D325,742; U.S. Pat. No. 5,212,329; U.S. Pat. No. 5,929,362; U.S. Pat. No.2008/0168884; and U.S. Pat. No. 7,671,268

While these aforementioned devices may fulfill their respective objectives They do not provide a new combination pickup, multi-effects processor and amplifying apparatus that is attachable, and detachable to an acoustical guitar battery powered independent device as the present invention does. They are cumbersome and impractical for everyday use. They do not provide on board multi-effects processing capabilities, neither provide a simple and effective means of attaching and detaching from the acoustic guitar, nor provide a device that could enhance the appearance of an acoustic guitar and therefore do not disclose a new combination pickup, multi-effects processor and amplifying apparatus that does enable a player of an acoustic guitar to produce, modify and amplify a myriad of sounds, and tones that are normally associated with that of an electrical guitar; Performing all of these functions while remaining suspended above the surface of the guitar's soundboard as an independent battery powered self-contained accessory that can be easily attached to, and detached from, an acoustic guitar with minimal intrusion to the body structure, appearance, and acoustical properties of the guitar.

In these respects the a combination pickup, multi-effects processor and amplifying apparatus that is attachable, and detachable to an acoustical guitar according to the present invention substantially departs from the conventional concepts and designs of the prior art, and in doing so provides an apparatus primarily developed for the purpose of enabling a player of an acoustic guitar to produce, modify and amplify a myriad of sounds, and tones that are normally associated with that of an electrical guitar; Performing all of these functions while remaining suspended above the surface of the guitar's soundboard as an independent self-contained accessory that can be easily attached to, and detached from, an acoustic guitar with minimal intrusion to the body structure, appearance, and acoustical properties of the guitar.

### SUMMARY OF THE INVENTION

In view of the disadvantages inherent in the known prior such as; being cumbersome and impractical for everyday use, not providing a battery powered independent device, not providing on board multi-effects processing capabilities, not providing a simple and effective means of attaching and detaching from the acoustic guitar, nor providing a device that does not diminish the appearance of an acoustic guitar. The present invention provides a new combination pickup, multi-effects processor and amplifying apparatus that is easily attachable, and detachable to an acoustical guitar while remaining an independent, battery powered device that is comfortable and does not hinder the path of the guitar player's strumming arm. Is practical for everyday use and is rendered in such a way that compliments the shape, contour and acoustical properties of an acoustic guitar.

The general purpose of the present invention, which will be described subsequently in greater detail, is to provide a new combination pickup, multi-effects processor and amplifying apparatus that is attachable, and detachable to an acoustical guitar and does enable a player of an acoustic guitar to produce and amplify a myriad of sounds, and tones that are normally associated with that of an electrical guitar; performing these functions while remaining an independent self-contained accessory that can be easily attached to and detached from an acoustic guitar with minimal intrusion to the body structure, appearance and acoustical properties of the guitar and having many of the advantages of the devices in the mentioned prior art and many novel features that result in a new combination pickup, multi-effects processor and amplifying apparatus that is attachable, and detachable to an acoustical guitar which is not suggested, anticipated or rendered obvious by any of the prior art

### BRIEF DESCRIPTION OF DRAWINGS

The invention will be better understood and objects other than those set forth above will become apparent when consideration is given to the following detailed description thereof. Such description makes reference to the annexed drawings wherein:

FIG. 1 is an illustration of the present invention with support arms, and pickup extended.

FIG. 2 is an illustration of the present invention in functioning position.

FIG. 3 is an illustration of the present invention prepared to lock into functioning position.

FIG. 4 the present invention before pickup arm is lowered.

FIG. 5 a cross sectional view of the invention in functioning position.

FIG. 6 front view of invention supports and pickup arm folded in.

FIG. 7 a back side view of invention supports and pickup arm folded in.

Before explaining at least one embodiment of the invention in detail, is to be understood that the invention is not limited in its application to the details of construction and to the arrangements all the components set forth in the following description or illustrated in the drawings. The invention is capable of other embodiments end up being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out that several purposes of the present invention. It is important, therefore, that the claims be regarded as including such equivalent constructions in so far as they do not depart from the spirit and scope of the present invention.

### DESCRIPTION OF THE PREFERRED EMBODIMENT

With reference now to the drawings, and in particular to 1 through 7 thereof, a new combination pickup, multi-effects processor and amplifying apparatus that is attachable, and detachable to an acoustical guitar embodying the principles and concepts of the present invention and generally designated by the reference numeral 10 will be described

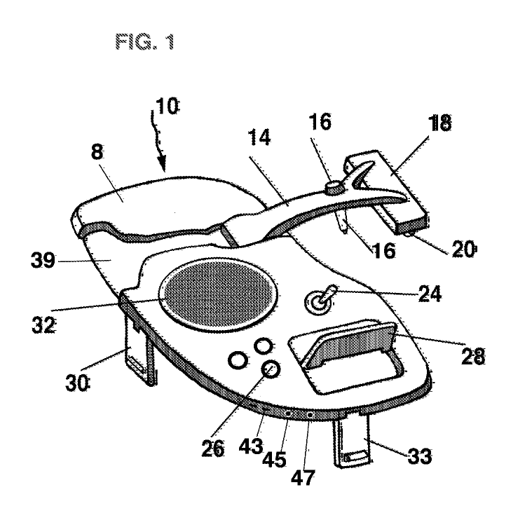

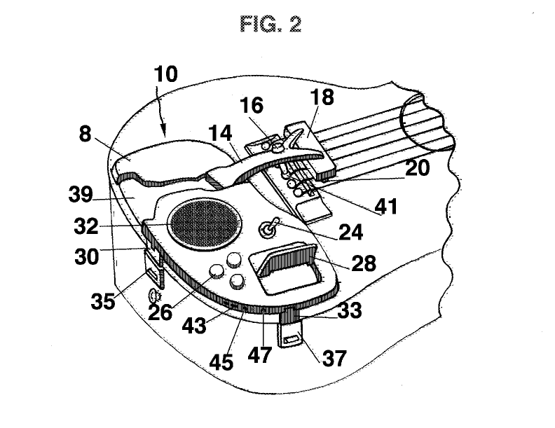

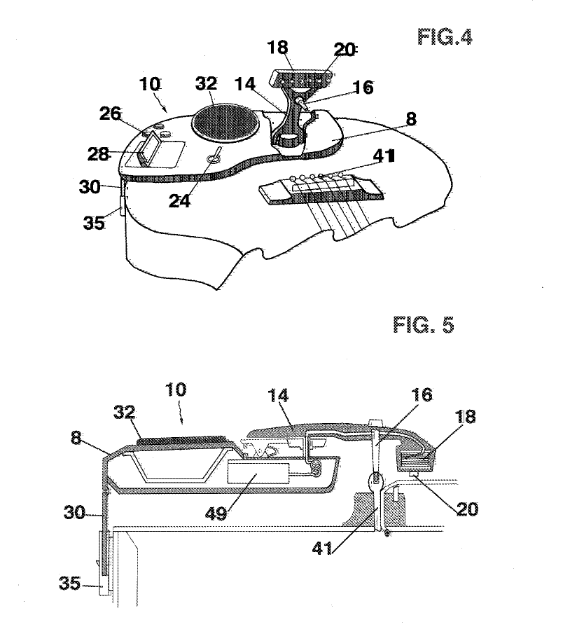

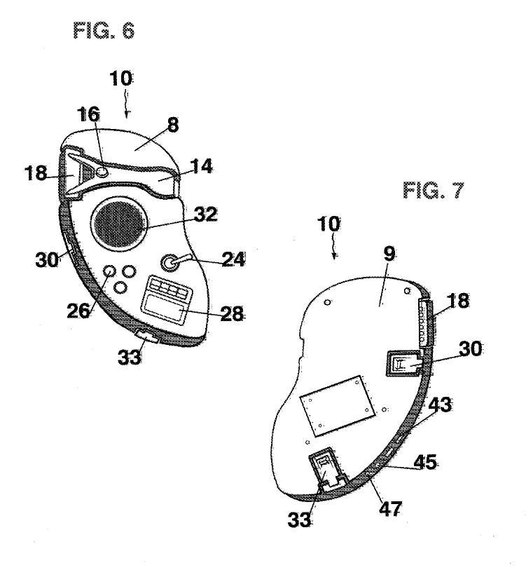

As best illustrated in FIGS. 1 through 7 The present invention Generally comprises a compartment 10 constructed of plastic, or a similar material that is suitable in rigidity and weight proportions as to create the optimal packaging. This compartment 10 does have a face panel 8, sides, and back panel 9, these do house the components of digital sound processing 49, a port for a rechargeable power source 43, input 45, and output ports 47 amplifier 32, and manual controls such as; dials 26, knobs, toggles 24 as well as the various visual displays 28 and an arm 14 that contains the magnetic transducer 18, commonly referred to as a pickup 18, that is adjustable and contractable.

The said compartment 10 is positioned in the area directly behind the bridge and does rise above the soundboard of the guitar. The bottom 9 surface of the compartment lies parallel to the soundboard suspended at a height that is no greater than one inch and continues at this plane until reaching the outer edge of the guitar, where the soundboard is joined to the side of the guitar. The sides of said compartment do follow the contour and profile of the guitar's side and do not come in contact with the soundboard.

The compartment 10 is held balanced, according to distribution of its weight and the dimensions of the guitar, in this suspended position above the soundboard by at least two vertical support bars that extend from it and dock onto the sides of the guitar. Both support bars 30,33 are foldable into the bottom 9 of the compartment 10 when compartment 10 is detached from guitar and in some embodiments will be adjustable to accommodate the different contours of the various models of guitars. One of the bars 30 is located in the area on a guitar referred to as the tail block, above the end pin that normally does protrude from the guitar, and the other near the lower bout 33 these bars 30,33 hold up the compartment 10 above the soundboard and secure the compartment to the sides of the guitar by means of a plastic, or suitable material, buckle type system. The male end forms 30,33 of the buckle type system on the support bar and the female receiving ends 35,37 being attached to the side of the guitar, the female receiving members 35,37 adhere to the side of the guitar using a Very High Bonding double sided tape. The double sided tape is strong enough to hold the compartment 10 in place, and yet can be removed with relative ease.

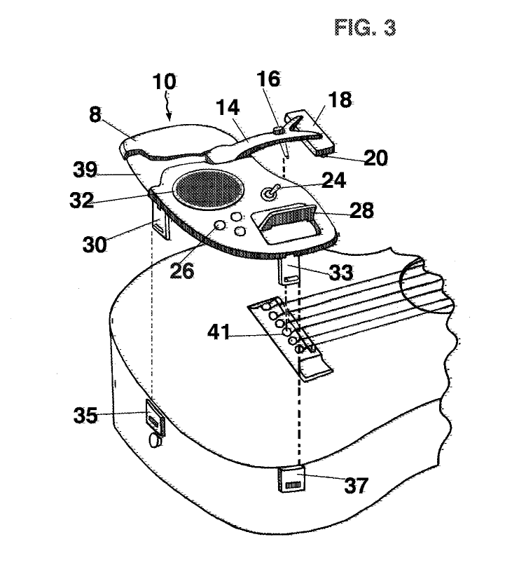

With the compartment 10 being held in position the male 30,33 end of the support bar above and aligned with its female 35,37 receiving end of the buckle type system below, as shown in FIG. 3, is then slid into place and stops when the male and female counter parts of the buckle type system have been fully joined. At this point the pickup arm 14 is moved from its docked position 39 on the face 8 of the compartment 10 and into its active position above the guitar strings. This pickup arm is adjusted by means of a threaded peg 16 that extends from the pickup arm 14 at a central location above the bridge pins 41. The threaded peg 16 does contact a bridge pin below 41. As the threaded peg 16 turns it engages corresponding threads in the pickup arm. A turn of the threaded peg 16 moves the magnetic heads 20 closer to the guitar strings and a turn in the opposite direction moves the heads away thus enabling the musician to adjust and lock the pickup arm 14 to a preferential distance between the magnetic heads 20 of the pickup 18 and the strings below. The musician can adjust the built in multi-effects processor 49 to any of its varied effects, styles and modes including but not limited to record and playback mode for accompaniment during soloing, and lead playing or practice.

There has thus Been outlined the more important features of the invention. As to a further discussion of the manner of usage and operation of the present invention, the same should be apparent from the above description. Accordingly, no further discussion relating to manner of usage and operation will be provided with respect to the above descriptions, is to be realized that the optimum dimensional relationship for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A combination pickup, multi-effects processor and amplifying apparatus comprising: a compartment, having a face, back and sides, that does house;
a magnetic transducer, also called a pickup, enclosed in a arm that extends from the compartment to reach out above the guitar strings.
a circuit board that contains the components for digitally modifying and transferring the signals received from the pickup that is above the strings.
a amplifier to project the digital signals
a port for a battery power source

2. A combination pickup, multi-effects processor and amplifying apparatus as in claim 1, wherein said apparatus is attachable to an acoustic guitar by means of;
at least two rigid support bars made of plastic or similar material, that hingedly extend from the apparatus acting as a buckle type system having male ends that clip into female receiving ends that are affixed to the sides of the guitar holding the apparatus suspended above the soundboard with the pickup in position above the strings of the guitar.
